(19) United States
(12) Patent Application Publication
(10) Pub. No.: US 2010/0198582 A1
(43) Pub. Date: Aug. 5, 2010

(54) Verbal command laptop computer and software

(76) Inventor: Gregory Walker Johnson, Dayton, OH (US)

Correspondence Address: Gregory Walker Johnson, 516 Dakota St., Dayton, OH, 45402, US

(21) Appl. No.: 12/322,310

(22) Filed: Feb. 2, 2009

(51) Int. Cl. G06F 17/20; G10L 21/00

(52) U.S. Cl. 704/8; 704/275; 704/E15.001; 704/271

(57) ABSTRACT

Nothing exists like this Verbal Command Laptop Computer and Software worldwide to transfer electronic information data of EDI. It can be used for the elderly when they need to scan something. Just set the item on a scanner and say, “scan, please.” The Verbal Command Laptop Computer and Software can be used to store names and addresses. Also, used as a fax machine. Just say, “fax, please” or “email please.” When user wishes to use email say, “check email please” or “send email please.” When wanting to use the Internet say, “Internet please” or for search engine say, “search engine.” The Verbal Command Laptop Computer and Software can handle all phases of a standard computer. The Verbal Command Laptop Computer and Software also has its own search engine. One can also use verbal command hands free with the Cordless Microphone or Verbal Head Set.

First is the concept for Verbal Command Laptop Computer and Software. The software can also be loaded into a desk top computer and cell phones. Used with verbal command head set and cordless microphone. Users can also talk with other verbal users like phone use. Second stage is to find a professional computer information system company that can put all response data into the Verbal Command Laptop Computer and Software needed to make it work by coming up with a professional prototype model. Once the model is in place, then it is time to market the new mandatory form of EDI because people have been waiting for something like this. It is not as tiring as a manual way of using the computer. Quicker access also. A microprocessor and memory chip will be developed for the Verbal Command Laptop Computer and Software. The memory chip will be 8 gigabytes to speed information. St. Gregory Technologies is working with professional people to develop this very needed computer for cell phone also headsets.

### BACKGROUND OF INVENTION

This invention relates to computer technologies and cell phones. Consumers can use the Verbal Command Laptop Computer and Software with manual typing or hands free verbal command. People around the world can talk to get shopping done. Just push VC on button and VC off to stop. Especially for blind talking to blind people and all ages can just ask the Verbal Command Laptop Computer and Software to give them the communication they need. Digital music player you can choose by verbal commands.

### Substitute Specification Contains No New Matter

### SUMMARY OF INVENTION

The Verbal Command Laptop Computer and Software will revolutionize the computer industry worldwide. Just pick up the Cordless Microphone or wear the Verbal Head Set and ask the Verbal Command Laptop Computer and Software to shop or make travel accommodations, math, program for email. Just say, “email please.” Everything that a standard computer does but it is done verbally. Verbally select digital music for MP3 players. Shopping also and talk to people just like a phone, consumers or family or friends.

### DETAILED DESCRIPTION OF THE INVENTION

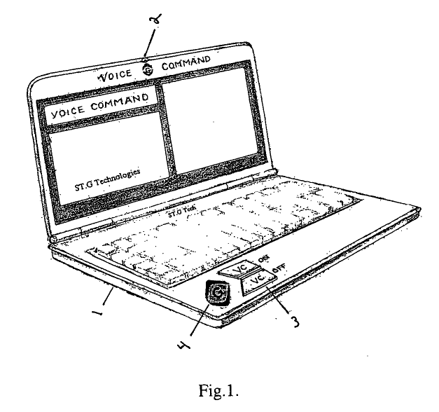

FIG. 1 shows front view of Verbal Command Laptop with verbal web camera at top and VC on and VC off buttons and built in microphone speakers next to the VC buttons and screen and key boards for manual use.

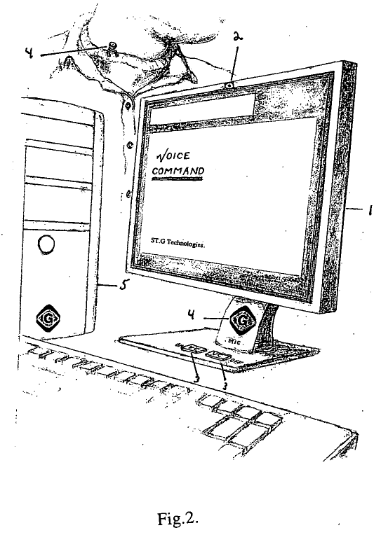

FIG. 2 shows front view of desktop verbal command monitor screen with verbal web camera to see other users and VC on and VC off buttons. And built in microphone speakers and portable wireless microphone around the neck of a user and a wireless desktop processor and standard features for manual use.

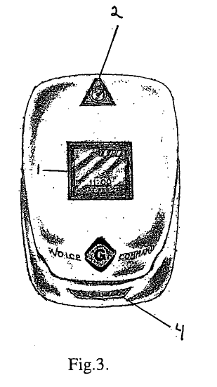

FIG. 3 shows front view of verbal command cell phone with verbal command camera at the top and day date and time window and logo.

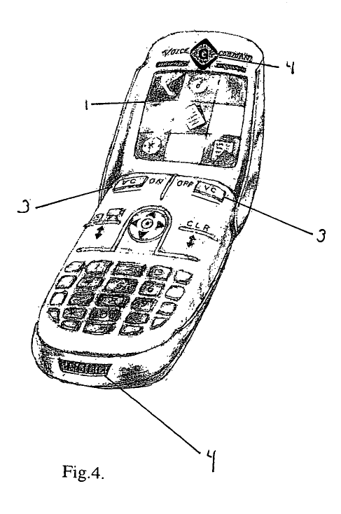

FIG. 4 shows the inside view of the verbal command cell phone with the menu screen and VC on and off buttons and all standard features for manual use when not using verbal commands.

FIG. 5 shows front view of verbal command Mp3 player with built in microphone for picking music and video selection by verbal command.

Shows front view of Star™ verbal command Mp3 player menu screen and verbal command camera so other cell phones and Mp3 users can see each other while talking; it doubles as a phone. Earplugs seen with microphone and manual menu button at bottom of Mp3 player.

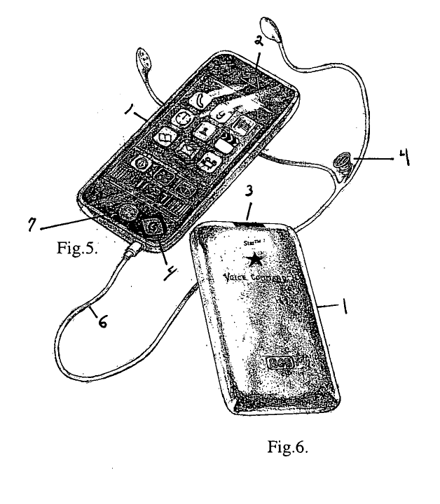

FIG. 6 shows back view with VC on and VC off button at the top middle area on the back of the verbal command Mp3 player and the Star™ logo and the 8 gigabytes sign shown at the bottom. Some units will have a special edition 18 kt gold solid on the back. Some will have a solid brass back. Some will have a pure copper back plate for the Mp3 player and some with a standard stainless steel.

I claim:

1. I am the creator and first to invent the Verbal Command Laptop Computer and Software and wireless desktop processor for surfing the Internet, and search engine to verbally choose various business endeavors.

2. I am the creator and first to create a hands free way of communication for EDI quick access for blind people worldwide, shopping, etc dependant as in claim 1.

3. I am the creator and first to invent the Verbal Command Laptop Computer and Software for use for the year, month, date and for verbal travel directions, accommodations and travel reservations maintaining business names, math, etc. dependent as in claim 1.

4. I am the creator and first to invent the Verbal Command Laptop Computer and Software for MP3 music and digital music player picking hits by verbal command dependent as in claim 1.

5. I am the creator and first to invent the Verbal Command Laptop Computer and Software for person-to-person phone use on the verbal command. You can speak with other verbal command owners dependent as in claim 1.

6. I am the creator and first to invent a verbal cell phone for total verbal with same application data as the Verbal Command Laptop Computer and Software. Also, creator of the caller ID verbally tells user who is calling especially good for blind persons. For example, Caller verbal ID can come in on verbal head set while wearing. Also, first to invent a fuel powered battery for the cell phone and computer for longer life use Also the first to invent a verbal spoken word on text messaging that comes out in a written format on the cell phone or computer screen to the person that the user is texting or emailing dependant as in claim 1.

7. I am the creator and first to invent the Verbal Command Laptop Computer that will use digital language software for learning any language (i.e, English, French, Spanish, German) and the verbal command cell phone for foreign language. For example, user asks for, “water please” in English in a French speaking country and it will verbally say “eau-see-voo-play,” will translate on user's cell phone screen and user can view and hear what is said in their native language and the French speaking person can view and hear what user says in their native language. ST G Tech Verbal Command will have available any language worldwide; Hebrew, Arabic, etc. For users worldwide who have a cell phone just take the cell phone along and foreigners can actually hear and see user's requests Good for travel, restaurant, etc and very good for blind people worldwide. Just ask the cell phone for the language that is needed and it will come up ready on the screen dependant as in claim 1.

8. I am the creator and first to invent the Verbal Command Laptop and Software and a program that changes television and radio channels by verbal command and software that allows one to verbally select DVD and CD and Mp3 players from a verbal command remote control system unit while on a docking station The system allows one to verbally record television programs as well for view at a later time dependent as in claim 1.

9. I am the creator and first to invent the Verbal Command Laptop and Software that has a verbal command, “click here please,” without using the standard way of clicking dependent as in claim 1.

10. I am the creator and first to invent the Verbal Command Laptop and Software for saying, “print please,” for a print out and verbal command weather report worldwide dependent as in claim 1.

11. I am the creator and first to invent the Verbal Command Laptop and Software that allows you to talk to another verbal command user by a cell phone to a laptop directly from a computer to a cell phone as well. For example, when calling someone from the cell phone to another computer user, one will see a green phone symbol or hear a sound by a verbal voice to let the user know a call is coming in The red phone symbol will end the call dependent as in claim 1.

12. I am the creator and first to invent the Verbal Command Laptop and Software for a camera and a web camera on a laptop and desktop and a cell phone for a verbal command. For example, just say, take a photo, and it will do it Take a picture and you can sort each picture by verbal command the cell phone will do the same For the laptop, desktop and cell phone; just say, web camera, and the user can see other web users It does everything a standard computer does except it is done by verbal command Dependent as in claim 1.

13. I am the creator and first to invent the verbal command hardware such as the Mp3 player for video and music with built in speakers and a VC on and VC off button, as well as a microphone and verbal command laptop and desktop hardware items that will have Verbal Command Software. The Star™ Mp3 Player by ST G Tech Verbal Command can be used for Internet shopping for fashion, verbal travel directions and accommodations. It features a menu button for manual use when not using verbally Movie Theater™ Software allows one to select movies to watch instantly Verbal texting and emailing with the Star™ Mp3 Player will talk to the user verbally to let one know what songs are on the album that are now playing. This is especially accommodating for blind people. The Star™ Mp3 Player can double as a phone, as well, which is also good for blind people The verbal volume level control is operated by saying, “Turn up” or “Turn down” or “Midway.” The Music Store™ Software allows one to select music and it is not transferable so there is no need to read and write a DVD or CD This could stop music theft PC users can use a microflash drive to store documents and information dependent as in claim 1.

14. I am the creator and first to invent the Solar verbal command cell phone And laptop with a Solar battery for the cell phone and the laptop and Desk top That creates energy from the Sun with a full charge it can Produce for five months with a natural exposure to light will power the Cell phone and laptop indefinitely, you no longer need to replace batteries A rechargeable built in battery stores energy collected with a solar cell in The cell phone The cell phone will be waterproof down to 328 ft and Will have a titanium case the cell phone and laptop and desktop will be Able to use manually as well. And the solar verbal command MP3 Player with a Solar battery as well.

15. I am the creator and first to invent the Verbal command software for the verbal pilot™ software that allows a Foreign language barrier for airplane pilots worldwide to communicate so a foreign air traffic controller can understand what the pilot is saying in their language while he speaks in his native language This could stop airplane crashes enormously Dependent as in claim 1.

16. I am the creator and first to Invent the Verbal command e-book and e-newspaper software to be read on your cell phone, computers, translated into into English from a Foreign language you can read French news paper or book it will come out on your screen in English so worldwide any language and it will verbally speak books and newspapers for the blind also with earplugs on so they can hear the book being read Select any chapter and verse or directly to sports, fashion ect Just ask the cellphone or computer to pull it up and it will And one can read or listen to a e-book or e-newspaper in any Foreign language if they prefer

17. I am the creator and first to Invent the Verbal command software Movie theater™ program that allows you to instantly buy a movie that is Showing at the Theater that has not been release on DVD yet the same day It opens at the theater you can buy and view the movie worldwide for home, And online, or cell phones Dependant as claim 1.

18. I am the creator and first to Invent the Verbal command software For E-mailing And that comes out in a written format on the cellphone or Computer for verbal command Faxing and scanning and copying on a printer Verbal command software for fashion models for names and height, and phone Numbers ect. Dependant as in claim 1.

19. I am the creator and first to Invent the verbal command software For video games and toy guns, driving cars all by verbal command on Television games as well And verbally gives time,day,date on the cellphone

20. I am the creator and first to Invent the Verbal Command Software For the e-book, e-newspaper, e-magazine, And the hardware with solar Battery for a tablet for digital use, All hardware units with a solar battery That charges from the Sun, for Digital Tablets,
The verbal command e-book, e-newspaper, e-magazine will Enhance reading but the big winner is that it is a green product The first environmental hardware created for computers All will have a solar battery. Dependant as in claim 1.
